(19) United States
(12) Patent Application Publication
(10) Pub. No.: US 2020/0405566 A1
(43) Pub. Date: Dec. 31, 2020

(54) BALANCE ASSISTANCE SYSTEM AND WEARABLE DEVICE

(71) Applicant: Wistron Corporation, New Taipei City (TW)

(72) Inventors: Hsiang-Min Chan, New Taipei City (TW); Yao-Tsung Chang, New Taipei City (TW); Chuan-Yen Kao, New Taipei City (TW); Yin-Yu Chen, New Taipei City (TW); Tsung-Yin Tsou, New Taipei City (TW)

(21) Appl. No.: 16/542,322

(22) Filed: Aug. 16, 2019

(30) Foreign Application Priority Data
Jun. 26, 2019 (TW) 108122318

(51) Int. Cl. A61H 3/00

(52) U.S. Cl. CPC A61H 3/00; A61H 2201/0173; A61H 2201/5058; A61H 2201/5007; A61H 2201/165

(57) ABSTRACT

A balance assistance system includes a rotating member, a first driving unit, a sensing module, and a processing unit. The first driving unit is connected to the rotating member. The first driving unit is configured to drive the rotating member to rotate. The processing unit is electrically connected to the first driving unit and the sensing module. The processing unit receives a sensing signal from the sensing module. The processing unit determines a current behavior mode from a plurality of behavior modes according to the sensing signal. The processing unit controls the first driving unit to adjust a rotating speed of the rotating member according to the current behavior mode.

### BACKGROUND OF THE DISCLOSURE

### 1. Field of the Disclosure

The disclosure relates to a balance assistance system and a wearable device and, more particularly, to a balance assistance system capable of assisting a user in balance to prevent the user from falling down and a wearable device equipped with the balance assistance system.

### 2. Description of the Prior Art

Due to the coming of aging society and lack of medical resource, exoskeleton becomes a major topic for robotic researchers. At present, the framework of the exoskeleton essentially consists of a plurality of motors and reducers. The exoskeleton detects a motion of a user by various sensors and controls the corresponding motor to adjust a joint angle and a posture of the user. Since the conventional exoskeleton is not equipped with a balance device, the user needs to balance by himself/herself or a cane. Once the user loses balance or gets hit, the user may fall down and be hurt.

### SUMMARY OF THE DISCLOSURE

The disclosure provides a balance assistance system capable of assisting a user in balance to prevent the user from falling down and a wearable device equipped with the balance assistance system, so as to solve the aforesaid problems.

According to an embodiment of the disclosure, a balance assistance system includes a rotating member, a first driving unit, a sensing module, and a processing unit. The first driving unit is connected to the rotating member. The first driving unit is configured to drive the rotating member to rotate. The processing unit is electrically connected to the first driving unit and the sensing module. The processing unit receives a sensing signal from the sensing module. The processing unit determines a current behavior mode from a plurality of behavior modes according to the sensing signal. The processing unit controls the first driving unit to adjust a rotating speed of the rotating member according to the current behavior mode.

According to another embodiment of the disclosure, a wearable device includes a wearable object and a balance assistance system. The balance assistance system is disposed on the wearable object. The balance assistance system includes a rotating member, a first driving unit, a sensing module, and a processing unit. The first driving unit is connected to the rotating member. The first driving unit is configured to drive the rotating member to rotate. The processing unit is electrically connected to the first driving unit and the sensing module. The processing unit receives a sensing signal from the sensing module. The processing unit determines a current behavior mode from a plurality of behavior modes according to the sensing signal. The processing unit controls the first driving unit to adjust a rotating speed of the rotating member according to the current behavior mode.

As mentioned in the above, the balance assistance system of the disclosure may be disposed on the wearable object (e.g. exoskeleton). When the wearable object is worn by a user and the balance assistance system is powered on, the first driving unit drives the rotating member to rotate to generate a moment of inertia. The moment of inertia generated by the rotating member may assist the user in balance to prevent the user from falling down. Furthermore, the sensing module generates the sensing signal according to a motion of the user. The balance assistance system of the disclosure may determine the current behavior mode of the user according to the sensing signal and adjust the rotating speed of the rotating member according to the current behavior mode of the user. Accordingly, the balance assistance system of the disclosure may flexibly adjust the moment of inertia generated by the rotating member according to different behavior modes of the user, so as to assist the user in balance in good time and avoid affecting normal motion of the user.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a wearable device according to an embodiment of the disclosure.

FIG. 2 is a perspective view illustrating the wearable device shown in FIG. 1 from another viewing angle.

FIG. 3 is a functional block diagram illustrating a balance assistance system shown in FIG. 1.

FIG. 4 is a flowchart illustrating a control manner of the balance assistance system shown in FIG. 3.

FIG. 5 is a front view illustrating a wearable device according to another embodiment of the disclosure.

FIG. 6 is a perspective view illustrating the balance assistance system shown in FIG. 5 after rotating.

FIG. 7 is a functional block diagram illustrating the balance assistance system shown in FIG. 5.

### DETAILED DESCRIPTION

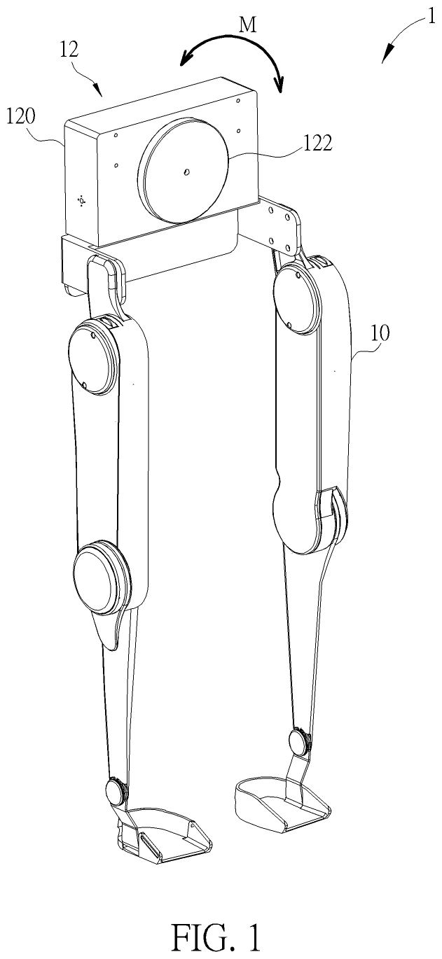

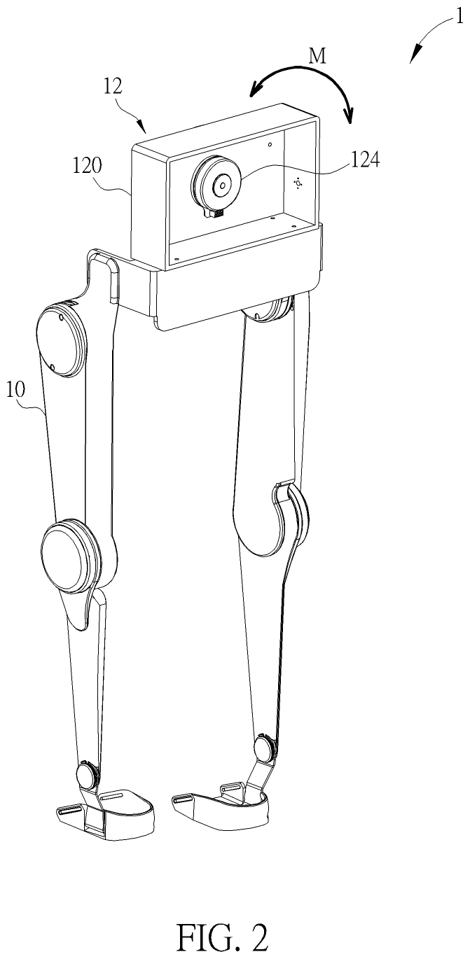

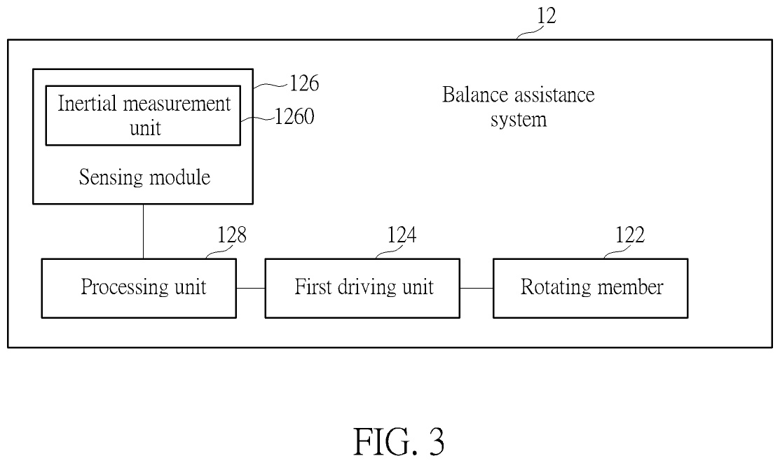

As shown in FIGS. 1 to 3, a wearable device 1 includes a wearable object 10 and a balance assistance system 12, wherein the balance assistance system 12 is disposed on the wearable object 10. It should be noted that the balance assistance system 12 may be disposed on any position of the wearable object 10 (e.g. waist, sole, etc.) according to practical applications, so the disclosure is not limited to the embodiment shown in the figure. In this embodiment, the wearable object 10 may be, but not limited to, an exoskeleton. Furthermore, the balance assistance system 12 of this embodiment disposed on the wearable object 10 is for illustration purpose. However, in another embodiment, the balance assistance system 12 may also be disposed on a movable robot or other movable objects according to practical applications.

The wearable object 10 may be worn by a user and the balance assistance system 12 may assist the user in balance to prevent the user from falling down. The balance assistance system 12 includes a casing 120, a rotating member 122, a first driving unit 124, a sensing module 126, and a processing unit 128. The rotating member 122 is disposed on the casing 120, wherein a rotating shaft of the rotating member 122 may be parallel or perpendicular to a desired direction for balance according to practical applications. The first driving unit 124 is disposed in the casing 120 and connected to the rotating member 122. The first driving unit 124 is configured to drive the rotating member 122 to rotate. The processing unit 128 is electrically connected to the first driving unit 124 and the sensing module 126. In this embodiment, the rotating member 122 may be a flywheel or the like, the first driving unit 124 may be a motor, and the processing unit 128 may be a processor or a controller with signal processing function.

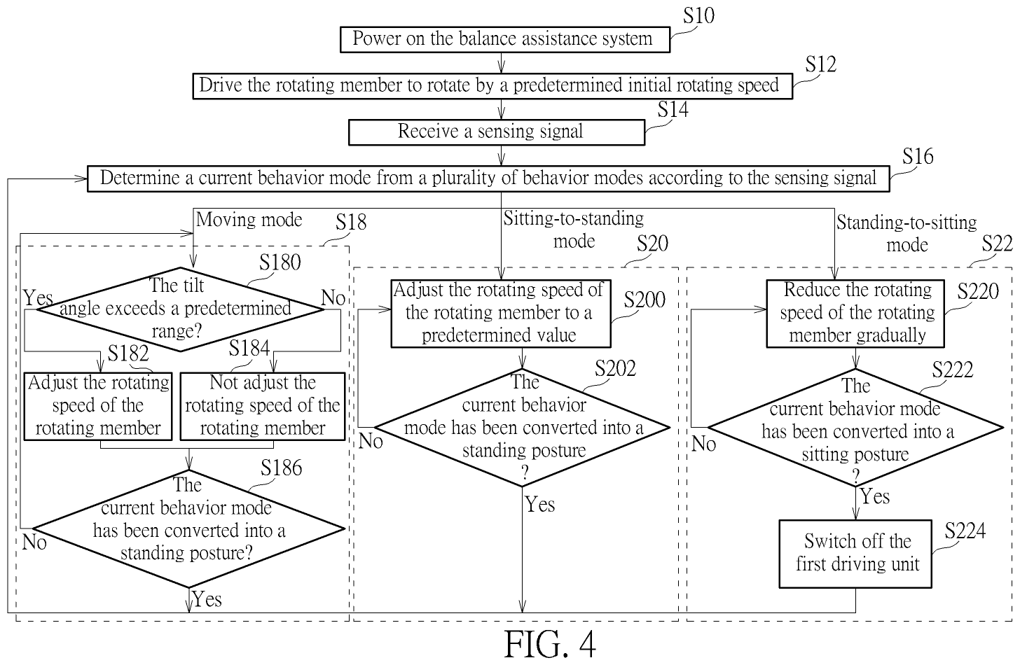

In this embodiment, when the balance assistance system 12 is powered on (step S10 in FIG. 4), the processing unit 128 may control the first driving unit 124 to drive the rotating member 122 to rotate by a predetermined initial rotating speed (step S12 in FIG. 4), so as to speedup reaction of the rotating member 122 for follow-up motion of the user and reduce reaction time of the rotating member 122. When the rotating member 122 rotates, the rotating member 122 generates a moment of inertia M. The predetermined initial rotating speed mentioned in the above may be determined according to practical applications. It should be noted that, in another embodiment, the step S12 in FIG. 4 may be omitted according to practical applications.

Then, the processing unit 128 receives a sensing signal from the sensing module 126 (step S14 in FIG. 4). Then, the processing unit 128 determines a current behavior mode from a plurality of behavior modes according to the sensing signal (step S16 in FIG. 4). In this embodiment, the plurality of behavior modes may include a moving mode, a sitting-to-standing mode, and a standing-to-sitting mode, but is not so limited. The behavior mode may be set according to practical applications. Furthermore, the sensing module 126 may include an inertial measurement unit (IMU) 1260, wherein the inertial measurement unit 1260 is configured to sense a tilt angle of the user.

In an embodiment of the disclosure, the sensing module 126 may further include a plurality of buttons (not shown) corresponding to the plurality of behavior modes. When the user presses one of the buttons, the button outputs the aforesaid sensing signal. At this time, the processing unit 128 may determine the current behavior mode from the plurality of behavior modes according to the sensing signal corresponding to the button.

In another embodiment of the disclosure, the sensing module 126 may further include a skin sensor, a force sensor, or a displacement sensor (not shown). At this time, the processing unit 128 may determine the current behavior mode of the user according to the sensing signal of the skin sensor, the force sensor, or the displacement sensor. It should be noted that the principle of the skin sensor, the force sensor, or the displacement sensor is well known by one skilled in the art, so it will not be depicted herein in detail.

After determining the current behavior mode, the processing unit 128 controls the first driving unit 124 to adjust a rotating speed of the rotating member 122 according to the current behavior mode (steps S18, S20, and S22 in FIG. 4).

When the current behavior mode is the moving mode (Step S18 in FIG. 4), the body of the user may naturally swing back and forth, such that the inertial measurement unit 1260 senses a tilt angle of the user. At this time, the processing unit 128 further determines whether the tilt angle sensed by the inertial measurement unit 1260 exceeds a predetermined range (step S180 in FIG. 4). When the processing unit 128 determines that the tilt angle of the user exceeds the predetermined range, the processing unit 128 controls the first driving unit 124 to adjust the rotating speed of the rotating member 122 according to a variation of the tilt angle of the user (step S182 in FIG. 4). In this embodiment, the tilt angle of the user may include a forward tilt angle and a backward tilt angle. Accordingly, the aforesaid predetermined range may be defined by the forward tilt angle θ1 and the backward tilt angle θ2. It should be noted that the aforesaid moving mode may include moving on a flat surface, moving upstairs or downstairs, or moving uphill or downhill. Furthermore, the forward tilt angle θ1 and the backward tilt angle 82 mentioned in the above may be determined according to different users and different moving manners, wherein the forward tilt angle θ1 and the backward tilt angle θ2 may be identical or different. For example, the forward tilt angle and the backward tilt angle for moving upstairs or downstairs and moving uphill or downhill are larger than the forward tilt angle and the backward tilt angle for moving on the flat surface.

Accordingly, when the processing unit 128 determines that the tilt angle of the user exceeds the predetermined range defined by the forward tilt angle θ1 and the backward tilt angle θ2, and the tilt angle is relatively large, it means that the user is quite possible to fall down. At this time, the processing unit 128 may control the first driving unit 124 to increase the rotating speed of the rotating member 122 as the tilt angle of the user increases, so as to increase the moment of inertia M generated by the rotating member 122. On the other hand, when the tilt angle exceeds the predetermined range defined by the forward tilt angle θ1 and the backward tilt angle θ2, and the tilt angle is relatively small, it means that the user has a low risk of falling down. At this time, the processing unit 128 may control the first driving unit 124 to reduce the rotating speed of the rotating member 122 as the tilt angle of the user reduces, so as to reduce the moment of inertia M generated by the rotating member 122. Furthermore, when the processing unit 128 determines that the tilt angle of the user does not exceed the predetermined range, the processing unit 128 does not adjust the rotating speed of the rotating member 122 (step S184 in FIG. 4). It should be noted that, in an embodiment of the disclosure, when the tilt angle of the user exceeds the predetermined range defined by the forward tilt angle θ1 and the backward tilt angle θ2, the rotating speed of the rotating member 122 may vary linearly in accordance with the tilt angle of the user. For example, the larger the tilt angle is, the faster the rotating speed of the rotating member 122 is; and the smaller the tilt angle is, the slower the rotating speed of the rotating member 122 is.

After adjusting or not adjusting the rotating speed of the rotating member 122, the processing unit 128 further determines whether the current behavior mode has been converted into a standing posture (step S186 in FIG. 4). For example, in an embodiment, the disclosure may determine whether the behavior mode has been converted into the standing posture by determining whether an angle of a hip joint and a knee joint of the wearable device 1 are respectively equivalent to a predetermined angle of the hip joint and a predetermined angle of the knee joint of the standing posture. When the processing unit 128 determines that the current behavior mode has been converted into the standing posture, the processing unit 128 determines the current behavior mode from the plurality of behavior modes according to the sensing signal again (step S16 in FIG. 4). On the other hand, when the processing unit 128 determines that the current behavior mode has not been converted into the standing posture yet, the processing unit 128 determines whether the tilt angle sensed by the inertial measurement unit 1260 exceeds the predetermined range again (step S180 in FIG. 4), so as to determine whether to adjust the rotating speed of the rotating member 122 (steps S182 and S184 in FIG. 4).

When the current behavior mode is the sitting-to-standing mode (Step S20 in FIG. 4), the body of the user needs to move forward by a wide margin to stand up. At this time, the processing unit 128 controls the first driving unit 124 to adjust the rotating speed of the rotating member 122 to a predetermined value (step S200 in FIG. 4). In this embodiment, the predetermined value is smaller than the aforesaid predetermined initial rotating speed and the predetermined value may be set according to practical applications. In other words, when the current behavior mode is the sitting-to-standing mode, the processing unit 128 controls the first driving unit 124 to reduce the rotating speed of the rotating member 122 from the predetermined initial rotating speed to the predetermined value, so as to reduce the moment of inertia M generated by the rotating member 122. Accordingly, the disclosure may prevent the rotating member 122 from generating too large moment of inertia M to affect the motion of the user from sitting to standing.

After adjusting the rotating speed of the rotating member 122 to the predetermined value, the processing unit 128 further determines whether the current behavior mode has been converted into the standing posture (step S202 in FIG. 4). When the processing unit 128 determines that the current behavior mode has been converted into the standing posture, the processing unit 128 determines the current behavior mode from the plurality of behavior modes according to the sensing signal again (step S16 in FIG. 4). On the other hand, when the processing unit 128 determines that the current behavior mode has not been converted into the standing posture yet, the processing unit 128 keeps controlling the first driving unit 124 to adjust the rotating speed of the rotating member 122 to the predetermined value (step S200 in FIG. 4).

When the current behavior mode is the standing-to-sitting mode (step S22 in FIG. 4), the user has a low risk of falling down. That is to say, the user may not need assistance of the balance assistance system 12 from standing to sitting. At this time, the processing unit 128 controls the first driving unit 124 to reduce the rotating speed of the rotating member 122 gradually (step S220 in FIG. 4), so as to save power.

While reducing the rotating speed of the rotating member 122, the processing unit 128 continuously determines whether the current behavior mode has been converted into a sitting posture (step S222 in FIG. 4). For example, in an embodiment, the disclosure may determine whether the behavior mode has been converted into the sitting posture by determining whether the angle of the hip joint and the angle of the knee joint of the wearable device 1 are respectively equivalent to a predetermined angle of the hip joint and a predetermined angle of the knee join of the sitting posture. When the processing unit 128 determines that the current behavior mode has been converted into the sitting posture, the processing unit 128 may switch off the first driving unit 124 (step S224 in FIG. 4) to save power. Then, the processing unit 128 determines the current behavior mode from the plurality of behavior modes according to the sensing signal again (step S16 in FIG. 4). On the other hand, when the processing unit 128 determines that the current behavior mode has not been converted into the sitting posture yet, the processing unit 128 keeps controlling the first driving unit 124 to reduce the rotating speed of the rotating member 122 gradually (step S220 in FIG. 4).

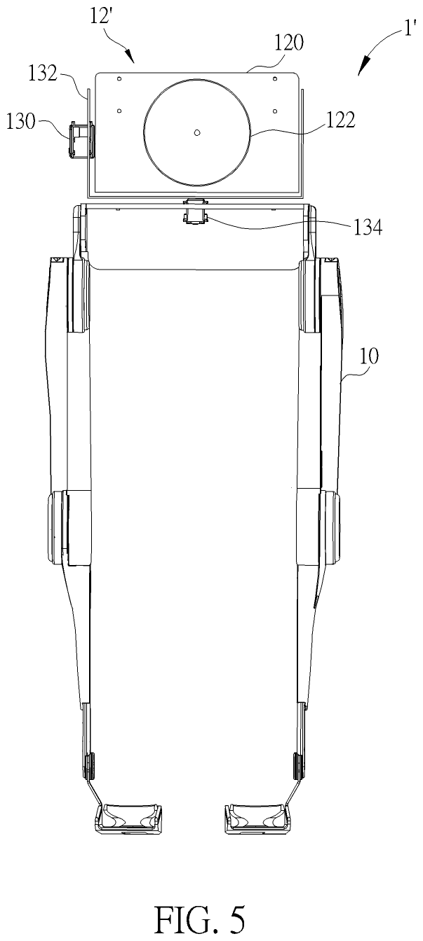

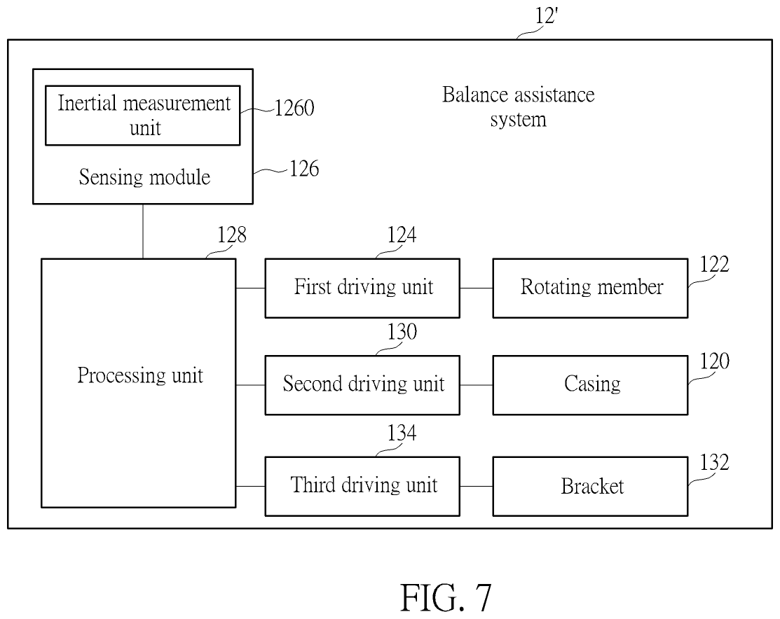

As shown in FIGS. 5 to 7, a balance assistance system 12′ of a wearable device 1′ of another embodiment may further include a second driving unit 130, a bracket 132, and a third driving unit 134. The casing 120 may be pivotally connected to the bracket 132. The second driving unit 130 may be disposed on the bracket 132 and connected to the casing 120. The second driving unit 130 is configured to drive the casing 120 to rotate. The third driving unit 134 may be disposed on the wearable object 10 and connected to the bracket 132. The third driving unit 134 is configured to drive the bracket 132 to rotate. Furthermore, the processing unit 128 is also electrically connected to the second driving unit 130 and the third driving unit 134. In this embodiment, the second driving unit 130 and the third driving unit 134 may be motors.

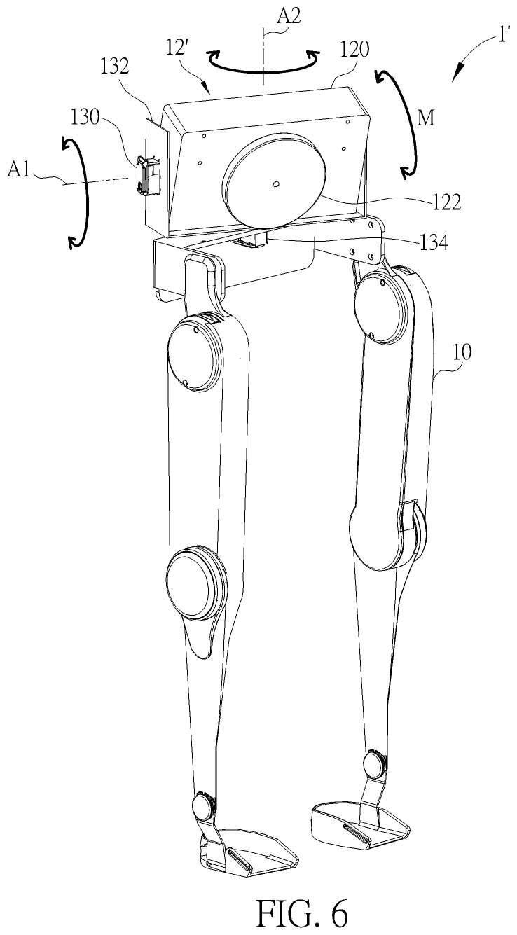

As shown in FIG. 6, the second driving unit 130 may drive the casing 120 to rotate with respect to a first axis A1 and the third driving unit 134 may drive the bracket 132 to rotate with respect to a second axis A2, wherein the first axis A1 is perpendicular to the second axis A2. Accordingly, the balance assistance system 12′ of the wearable device 1′ may change a direction of the moment of inertia M generated by the rotating member 122, so as to provide balance assistance for the user in any direction. For example, once the user is almost to fall down, the second driving unit 130 may drive the casing 120 to rotate and the third driving unit 134 may drive the bracket 132 to rotate to make the rotating shaft of the rotating member 122 parallel to a falling direction of the user, so as to provide the moment of inertia M for the user more precisely.

As mentioned in the above, the balance assistance system of the disclosure may be disposed on the wearable object (e.g. exoskeleton). When the wearable object is worn by a user and the balance assistance system is powered on, the first driving unit drives the rotating member to rotate to generate a moment of inertia. The moment of inertia generated by the rotating member may assist the user in balance to prevent the user from falling down. Furthermore, the sensing module generates the sensing signal according to a motion of the user. The balance assistance system of the disclosure may determine the current behavior mode of the user according to the sensing signal and adjust the rotating speed of the rotating member according to the current behavior mode of the user. Accordingly, the balance assistance system of the disclosure may flexibly adjust the moment of inertia generated by the rotating member according to different behavior modes of the user, so as to assist the user in balance in good time and avoid affecting normal motion of the user.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A balance assistance system comprising:
a rotating member;
a first driving unit connected to the rotating member, the first driving unit being configured to drive the rotating member to rotate;
a sensing module; and
a processing unit electrically connected to the first driving unit and the sensing module, the processing unit receiving a sensing signal from the sensing module, the processing unit determining a current behavior mode from a plurality of behavior modes according to the sensing signal, the processing unit controlling the first driving unit to adjust a rotating speed of the rotating member according to the current behavior mode.

2. The balance assistance system of claim 1, wherein the sensing module comprises an inertial measurement unit; when the current behavior mode is a moving mode, the processing unit determines whether a tilt angle sensed by the inertial measurement unit exceeds a predetermined range; when the processing unit determines that the tilt angle exceeds the predetermined range, the processing unit controls the first driving unit to adjust the rotating speed of the rotating member according to a variation of the tilt angle.

3. The balance assistance system of claim 2, wherein after adjusting the rotating speed of the rotating member, the processing unit determines whether the current behavior mode has been converted into a standing posture; when the processing unit determines that the current behavior mode has been converted into the standing posture, the processing unit determines the current behavior mode from the plurality of behavior modes according to the sensing signal again.

4. The balance assistance system of claim 1, wherein when the current behavior mode is a sitting-to-standing mode, the processing unit controls the first driving unit to adjust the rotating speed of the rotating member to a predetermined value.

5. The balance assistance system of claim 4, wherein after adjusting the rotating speed of the rotating member to the predetermined value, the processing unit determines whether the current behavior mode has been converted into a standing posture; when the processing unit determines that the current behavior mode has been converted into the standing posture, the processing unit determines the current behavior mode from the plurality of behavior modes according to the sensing signal again.

6. The balance assistance system of claim 1, wherein when the current behavior mode is a standing-to-sitting mode, the processing unit controls the first driving unit to reduce the rotating speed of the rotating member gradually.

7. The balance assistance system of claim 6, wherein while reducing the rotating speed of the rotating member, the processing unit determines whether the current behavior mode has been converted into a sitting posture; when the processing unit determines that the current behavior mode has been converted into the sitting posture, the processing unit switches off the first driving unit and determines the current behavior mode from the plurality of behavior modes according to the sensing signal again.

8. The balance assistance system of claim 1, wherein when the balance assistance system is powered on, the processing unit controls the first driving unit to drive the rotating member to rotate by a predetermined initial rotating speed.

9. The balance assistance system of claim 1, further comprising a casing and a second driving unit, the rotating member being disposed on the casing, the first driving unit being disposed in the casing, the second driving unit being connected to the casing, the processing unit being electrically connected to the second driving unit, and the second driving unit being configured to drive the casing to rotate with respect to a first axis.

10. The balance assistance system of claim 9, further comprising a bracket and a third driving unit, the casing being pivotally connected to the bracket, the third driving unit being connected to the bracket, the processing unit being electrically connected to the third driving unit, the third driving unit being configured to drive the bracket to rotate with respect to a second axis, and the first axis being perpendicular to the second axis.

11. A wearable device comprising:
a wearable object; and
a balance assistance system disposed on the wearable object, the balance assistance system comprising:
a rotating member;
a first driving unit connected to the rotating member, the first driving unit being configured to drive the rotating member to rotate;
a sensing module; and
a processing unit electrically connected to the first driving unit and the sensing module, the processing unit receiving a sensing signal from the sensing module, the processing unit determining a current behavior mode from a plurality of behavior modes according to the sensing signal, the processing unit controlling the first driving unit to adjust a rotating speed of the rotating member according to the current behavior mode.

12. The wearable device of claim 11, wherein the sensing module comprises an inertial measurement unit; when the current behavior mode is a moving mode, the processing unit determines whether a tilt angle sensed by the inertial measurement unit exceeds a predetermined range; when the processing unit determines that the tilt angle exceeds the predetermined range, the processing unit controls the first driving unit to adjust the rotating speed of the rotating member according to a variation of the tilt angle.

13. The wearable device of claim 12, wherein after adjusting the rotating speed of the rotating member, the processing unit determines whether the current behavior mode has been converted into a standing posture; when the processing unit determines that the current behavior mode has been converted into the standing posture, the processing unit determines the current behavior mode from the plurality of behavior modes according to the sensing signal again.

14. The wearable device of claim 11, wherein when the current behavior mode is a sitting-to-standing mode, the processing unit controls the first driving unit to adjust the rotating speed of the rotating member to a predetermined value.

15. The wearable device of claim 14, wherein after adjusting the rotating speed of the rotating member to the predetermined value, the processing unit determines whether the current behavior mode has been converted into a standing posture; when the processing unit determines that the current behavior mode has been converted into the standing posture, the processing unit determines the current behavior mode from the plurality of behavior modes according to the sensing signal again.

16. The wearable device of claim 11, wherein when the current behavior mode is a standing-to-sitting mode, the processing unit controls the first driving unit to reduce the rotating speed of the rotating member gradually.

17. The wearable device of claim 16, wherein while reducing the rotating speed of the rotating member, the processing unit determines whether the current behavior mode has been converted into a sitting posture; when the processing unit determines that the current behavior mode has been converted into the sitting posture, the processing unit switches off the first driving unit and determines the current behavior mode from the plurality of behavior modes according to the sensing signal again.

18. The wearable device of claim 11, wherein when the balance assistance system is powered on, the processing unit controls the first driving unit to drive the rotating member to rotate by a predetermined initial rotating speed.

19. The wearable device of claim 11, wherein the balance assistance system further comprises a casing and a second driving unit, the rotating member is disposed on the casing, the first driving unit is disposed in the casing, the second driving unit is connected to the casing, the processing unit is electrically connected to the second driving unit, and the second driving unit is configured to drive the casing to rotate with respect to a first axis.

20. The wearable device of claim 19, wherein the balance assistance system further comprises a bracket and a third driving unit, the casing is pivotally connected to the bracket, the third driving unit is connected to the bracket, the processing unit is electrically connected to the third driving unit, the third driving unit is configured to drive the bracket to rotate with respect to a second axis, and the first axis is perpendicular to the second axis.
